(19) United States
(12) Patent Application Publication
(10) Pub. No.: US 2006/0180759 A1
(43) Pub. Date: Aug. 17, 2006

(54) System and method for controlling pyroelectric sensors in a focal plane array

(76) Inventors: Joseph V. Mantese, Shelby Township, MI (US); Andrzej M. Pawlak, Rochester Hills, MI (US)

Correspondence Address: DELPHI TECHNOLOGIES, INC., M/C 480-410-202, PO BOX 5052, TROY, MI, 48007, US

(21) Appl. No.: 11/353,561

(22) Filed: Feb. 14, 2006

Related U.S. Application Data
(60) Provisional application No. 60/653,002, filed on Feb. 15, 2005.

(51) Int. Cl. G01J 5/00

(52) U.S. Cl. 250/338.3

(57) ABSTRACT

A system and a method for controlling pyroelectric sensors in a focal plane array are provided. The method includes applying a first oscillatory voltage waveform to first and second pyroelectric sensors in the focal plane array such that the first and second pyroelectric sensors receive a first predetermined number of cycles of the first oscillatory voltage waveform over a first time period. The first pyroelectric sensor receives infrared radiation thereon. The method further includes generating a first output signal using the first and second pyroelectric, sensors during the first time period indicative of a temperature of the first pyroelectric sensor. The method further includes applying a second oscillatory voltage waveform to third and fourth pyroelectric sensors in the focal plane array such that the third and fourth pyroelectric sensors receive a second predetermined number of cycles of the first oscillatory voltage waveform over the first time period. The third pyroelectric sensor receives infrared radiation thereon. The method further includes generating a second output signal using the third and fourth pyroelectric sensors during the first time period indicative of a temperature of the third pyroelectric sensor.

### CROSS REFERENCE TO RELATED APPLICATIONS

The application claims the benefit of U.S. Provisional application Ser. No. 60/653,002, filed Feb. 15, 2005, the contents of which are incorporated herein by reference thereto.

### TECHNICAL FIELD

This application relates to a system and a method for controlling pyroelectric sensors in a focal plane array.

### BACKGROUND

Focal plane arrays have been developed that utilize a plurality of pyroelectric sensors. Each pyroelectric sensor generates an electrical charge based upon a temperature of the pyroelectric sensor. A drawback with the focal plane array, however, is that each pyroelectric sensor operates in a passive mode where no external signal is applied to the pyroelectric sensor. As a result, each of the pyroelectric sensors in the focal plane array has a substantially similar signal-to-noise ratio and a substantially similar sensitivity. Thus, the focal plane array are not utilized in applications where different signal-to-noise ratios or different sensitivities associated with pyroelectric sensors in the focal plane array are desired.

Thus, there is a need for a focal plane array having pyroelectric sensors where signal-to-noise ratios and sensitivities of the ferroelectric sensors can be individually adjusted.

### SUMMARY

A method for controlling pyroelectric sensors in a focal plane array in accordance with an exemplary embodiment is provided. The method includes applying a first oscillatory voltage waveform to first and second pyroelectric sensors in the focal plane array such that the first and second pyroelectric sensors receive a first predetermined number of cycles of the first oscillatory voltage waveform over a first time period. The first pyroelectric sensor receives infrared radiation thereon. The method further includes generating a first output signal using the first and second pyroelectric sensors during the first time period indicative of a temperature of the first pyroelectric sensor. The method further includes applying a second oscillatory voltage waveform to third and fourth pyroelectric sensors in the focal plane array such that the third and fourth pyroelectric sensors receive a second predetermined number of cycles of the second oscillatory voltage waveform over the first time period. The third pyroelectric sensor receives infrared radiation thereon. The method further includes generating a second output signal using the third and fourth pyroelectric sensors during the first time period indicative of a temperature of the third pyroelectric sensor.

A system for controlling pyroelectric sensors in a focal plane array in accordance with another exemplary embodiment is provided. The system includes a voltage source configured to apply a first oscillatory voltage waveform to first and second pyroelectric sensors in the focal plane array such that the first and second pyroelectric sensors receive a first predetermined number of cycles of the first oscillatory voltage waveform over a first time period. The first pyroelectric sensor receives infrared radiation thereon. The system further includes a first electrical circuit configured to generate a first output signal using the first and second pyroelectric sensors during the first time period indicative of a temperature of the first pyroelectric sensor. The voltage source is further configured to apply a second oscillatory voltage waveform to third and fourth pyroelectric sensors in the focal plane array such that the third and fourth pyroelectric sensors receive a second predetermined number of cycles of the second oscillatory voltage waveform over the first time period. The system further includes a second electrical circuit configured to generate a second output signal using the third and fourth pyroelectric sensors during the first time period indicative of a temperature of the second pyroelectric sensor.

### BRIEF DESCRIPTION OF THE DRAWINGS

FIG. 1 is a block diagram of a system for controlling a focal plane array in accordance with an exemplary embodiment;

FIG. 2 is a top view of the focal plane array shown in FIG. 1;

FIG. 3 is a schematic of a first oscillatory voltage waveform utilized in the system of FIG. 1;

FIG. 4 is a schematic of a second oscillatory voltage waveform utilized in the system of FIG. 1; and

FIG. 5 is a flowchart of a method for controlling pyroelectric sensor in a focal plane array.

### DESCRIPTION OF EXEMPLARY EMBODIMENTS

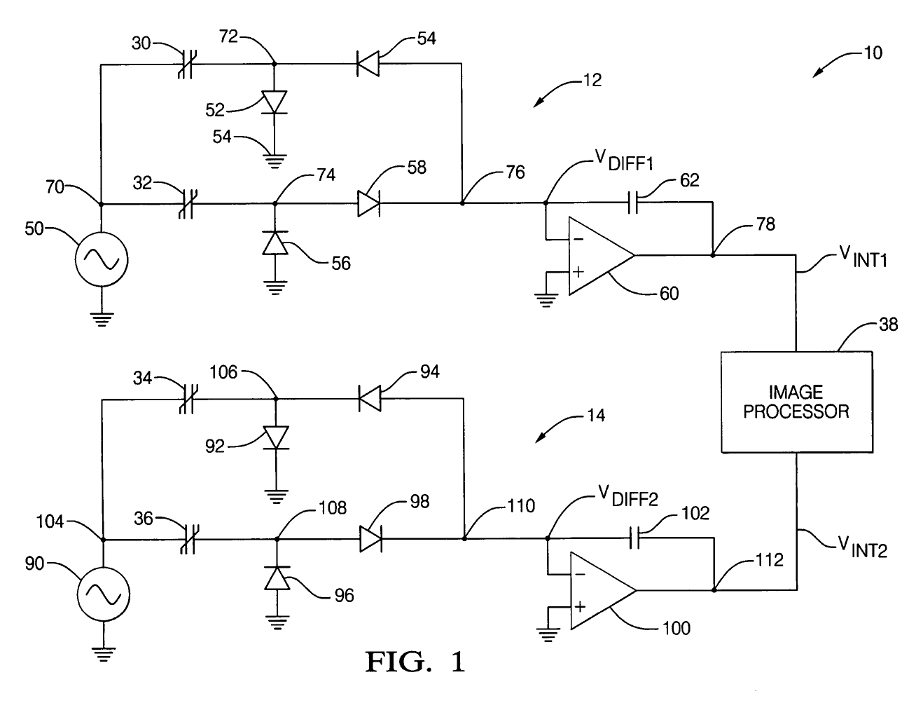

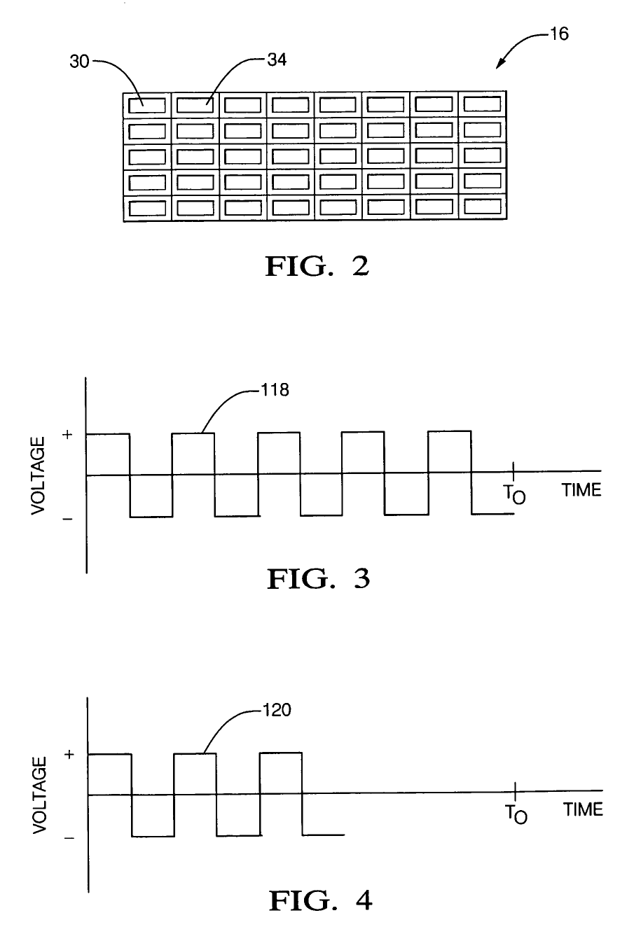

Referring to FIGS. 1 and 2, a system 10 for controlling pyroelectric sensors in the focal plane array 16 is illustrated. The system includes an electrical circuit 12, an electrical circuit 14, a focal plane array 16, and an image processor 38. The focal plane array 16 comprises a plurality of pyroelectric sensors including sensors 30, 34. Each of the pyroelectric sensors in the focal plane array 16 exposed to infrared light generates a signal indicative of a temperature of a portion of an image scene that is detected by the pyroelectric sensors. An advantage of the system 10 is that a signal-to-noise ratio of output signals indicative of temperature of the pyroelectric sensors 30, 34 generated by the electrical circuits 12, 14 is increased, as compared with other systems. Further, a sensitivity of the output signals can be varied.

The electric circuit 12 is provided to switch the pyroelectric sensors 30, 32 between first and second polarization states such that the circuit 12 generates a differential signal indicative of a temperature of the sensor 30. The electric circuit 12 includes a voltage source 50, the pyroelectric sensors 30, 32, diodes 52, 54, 56, 58, an operational amplifier 60, and a capacitor 62. The voltage source 50 is electrically coupled to the pyroelectric sensors 30, 32 at the node 70. The pyroelectric sensor 30 is further electrically coupled to the node 72. The diode 52 has an anode electrically coupled to the node 72 and a cathode electrically coupled to a system ground 54. The diode 54 has an anode electrically coupled to a node 76 and a cathode electrically coupled to the node 72. Further, the pyroelectric sensor 32 is electrically coupled to the node 74. Further, the diode 56 has a cathode electrically coupled to the node 74 and an anode electrically coupled to the system ground. The diode 58 has an anode electrically coupled to the node 74 and a cathode electrically coupled to the node 76. Still further, the operational amplifier 60 includes a non-inverting terminal, an inverting terminal, and an output terminal. The non-inverting terminal of the operational amplifier 60 is electrically coupled to system ground. The inverting terminal of the operational amplifier 60 is electrically coupled to the node 76. The capacitor 62 is electrically coupled between the nodes 76, 78 and the node 78 is further electrically coupled to the output terminal of the operational amplifier 60. Finally, the node 78 is electrically coupled to the image processor 38.

The voltage source 50 is provided to generate an oscillatory voltage waveform 118 is transmitted to the pyroelectric electric sensors 30, 32. Referring to FIG. 3, the oscillatory voltage waveform 118 comprises a pulse-width modulated voltage waveform. It should be noted, however, that in an alternate embodiment, the oscillatory voltage waveform can comprise any oscillating voltage waveform, known to those skilled in the art. For example, the oscillatory voltage waveform can comprise an AC voltage waveform, a triangular-shaped voltage waveform, and a sawtooth-shaped voltage waveform. When the waveform 118 has a positive voltage, the polarization states of the pyroelectric sensors 30, 32 are switched toward a first polarization state and when the waveform 118 has a negative voltage, the polarization is switched toward a second polarization state.

The pyroelectric sensors 30, 32 of the focal plane array 16 are provided to generate output voltages that will be utilized by the circuit 12 to generate output signal (V_{Int1}) indicating an average temperature of the pyroelectric sensor 30. The pyroelectric sensor 30 is exposed to infrared radiation from a portion of physical environment. The pyroelectric sensor 32 is not exposed to any incoming infrared radiation, and generates a reference charge Q_{Reference1}. When a temperature of the pyroelectric sensor 30 is greater than a temperature of the sensor 32, the polarization of the pyroelectric sensor 30 is less than a polarization of the pyroelectric sensor 32. Further, an amount of electrical charge generated by the pyroelectric sensor 30 is less than an amount of electrical charge generated by the pyroelectric sensor 32. Alternately, when a temperature of the pyroelectric sensor 30 is less than a temperature of the sensor 32, the polarization of the pyroelectric sensor 30 is greater than a polarization of the pyroelectric sensor 32. Further, an amount of electrical charge generated by the pyroelectric sensor 30 is less than an amount of electrical charge generated by the pyroelectric sensor 32.

The pyroelectric sensors 30, 32 are constructed from a ferroelectric material strontium bismuth tantalate (SBT) (SrBi2Ta209). However, in alternate embodiments other ferroelectric materials or the like can be utilized for the pyroelectric sensors. When the voltage source 50 transmits an oscillatory voltage waveform 118 to the pyroelectric sensors 30, 32, the pyroelectric sensors 30, 32 switch between a first polarization state and a second polarization state. Each time the pyroelectric sensors 30, 32 switch from an unpoled state, an electrical charge Qₛ₁ is applied from the voltage source 50 to the pyroelectric sensor 30. The electrical charge Qₛ₁ can be calculated using the following equation:
Qₛ₁=A1*Pₛ₁
where:
A1 is the area of the pyroelectric sensor 30;
Pₛ₁ is a change in spontaneous polarization per unit volume of the pyroelectric sensor 30 due to a temperature change ΔTₚ₁.
If the positive or negative electrical charge of the pyroelectric sensor 30 is integrated over a predetermined time period, the total charge accumulated for a predetermined number of cycles N1 of the voltage waveform 118 can be calculated utilizing the following equation:
Q_{Total1}=N1*Qₛ₁=N1*A1*Pₛ₁
Further, the total charge Q_{Total1} is indicative of the temperature of the pyroelectric sensor 30.

The electric circuit 12 generates a signal V_{Diff1} on the node 76 in response to the voltage waveform 118 corresponding to a difference between the Q_{Total1} electrical charge of the pyroelectric sensor 30 and the Q_{Reference1} electrical charge of the pyroelectric sensor 32. The operational amplifier 60 in conjunction with the capacitor 62 integrates the signal V_{Diff1} over a predetermined time period to generate the signal V_{Int1}, that is indicative of an average temperature of the pyroelectric sensor 30. It should be noted that by integrating the signal V_{Diff1} over time, incoherent noise in the signal V_{Diff1} is canceled out and the signal-to-noise ratio of the signal V_{Int1} is greater than the signal V_{Diff1}. In particular, the signal-to-noise ratio of the signal V_{Int1} is increased by N1^{1/2} for random Gaussian noise, as compared to the signal-to-noise ratio of the voltage signal V_{Diff1}, where N1 represents the number of cycles of the voltage waveform 118 applied to the pyroelectric sensor 30.

Further, an active mode effective pyroelectric coefficient P_{eff} for the pyroelectric sensor 30 is defined by the following equation:
P_{eff}=ΔQ1/A1*ΔTₚ₁=N1*ΔPₛ₁/ΔTₚ₁
where:
ΔQ1 is a change in electrical charge of the pyroelectric sensor 30;
A1 is an area of the pyroelectric sensor 30;
ΔTₚ₁ is a change in a temperature of the pyroelectric sensor 30;
N1 is the number of cycles of the voltage signal 118 applied to the pyroelectric sensor 30; and
ΔPₛ₁ is a change in spontaneous polarization per unit volume of the pyroelectric sensor due to a temperature change ΔTₚ₁.

The electric circuit 14 is provided to switch the pyroelectric sensors 34, 36 between first and second polarization states such that the circuit 14 generates a differential signal indicative of a temperature of the sensor 34. The electric circuit 14 includes a voltage source 90, the pyroelectric sensors 34, 36, diodes 92, 94, 96, 98, an operational amplifier 100, and a capacitor 102. The voltage source 90 is electrically coupled to the pyroelectric sensors 34, 36 at the node 104. The pyroelectric sensor 34 is further electrically coupled to the node 106. The diode 92 has an anode electrically coupled to the node 106 and a cathode electrically coupled to system ground 54. The diode 94 has an anode electrically coupled to the node 110 and a cathode electrically coupled to the node 106. Further, the pyroelectric sensor 36 is electrically coupled to the node 108. Further, the diode 96 has a cathode electrically coupled to the node 108 and an anode electrically coupled to the system ground. Further, the diode 98 has an anode electrically coupled to the node 108 and a cathode electrically coupled to the node 110. Still further, the operational amplifier 100 includes a non-inverting terminal, an inverting terminal, and an output terminal. The non-inverting terminal of the operational amplifier 100 is electrically coupled to system ground. The inverting terminal of the operational amplifier 100 is electrically coupled to the node 110. The capacitor 102 is electrically coupled between the nodes 110, 112 and the node 112 is further electrically coupled to the output terminal of the operational amplifier 100. Finally, the node 112 is electrically coupled to the image processor 38.

The voltage source 90 is provided to generate an oscillatory voltage waveform 120 that is transmitted to the pyroelectric electric sensors 34, 36. Referring to FIG. 4, the oscillatory voltage waveform 120 comprises a pulse-width modulated voltage waveform. It should be noted, however, that in an alternate embodiment, the oscillatory voltage waveform can comprise any oscillating voltage waveform, known to those skilled in the art. For example, the oscillatory voltage waveform to comprise an AC voltage waveform, a triangular-shaped voltage waveform, and a sawtooth-shaped voltage waveform. When the waveform 120 has a positive voltage, the polarization states of the pyroelectric sensors 34, 36 are switched toward a first polarization state and when the waveform 120 has a negative voltage, the polarization is switched toward a second polarization state.

The pyroelectric sensors 34, 36 of the focal plane array 16 are provided to generate output voltages that will be utilized by the circuit 12 to generate output signal (V_{Int2}) indicating an average temperature of the pyroelectric sensor 34. The pyroelectric sensor 34 is exposed to infrared radiation from a portion of a physical environment. The pyroelectric sensor 36 is not exposed any incoming infrared radiation, and generates a reference change Q_{Reference2}. When a temperature of the pyroelectric sensor 34 is greater than a temperature of the sensor 36, the polarization of the pyroelectric sensor 34 is less than a polarization of the pyroelectric sensor 36. Further, an amount of electrical charge generated by the pyroelectric sensor 34 is less than an amount of electrical charge generated by the pyroelectric sensor 36.

Alternately, when a temperature of the pyroelectric sensor 34 is less than a temperature of the sensor 36, the polarization of the pyroelectric sensor 34 is greater than a polarization of the pyroelectric sensor 36. Further, an amount of electrical charge generated by the pyrolectric sensor 34 is less than an amount of electrical charge generated by the pyroelectric sensor 36.

The pyroelectric sensors 34, 36 are constructed from the ferroelectric material strontium bismuth tantalate (SBT) (SrBi2Ta209). When the voltage source 90 transmits an oscillatory voltage waveform 120 to the pyroelectric sensors 34, 36, the pyroelectric sensors 34, 36 switch between a first polarization state and a second polarization state. Each time the pyroelectric sensors 34, 36 switch from an unpoled state, an electrical charge Qₛ₂ is applied from the voltage source 90 to the pyroelectric sensors 36. The electrical charge Qₛ₂ can be calculated using the following equation:
Qₛ₂=A2*Pₛ₂
where:
A2 is an area of the pyroelectric sensor 34;
Pₛ₂ is a change in spontaneous polarization per unit of volume of the pyroelectric sensor 34 due to a temperature change ΔTₚ₂.
If the positive or negative electrical charge delivered to the pyroelectric sensor 34 is integrated over a predetermined time period, the total charge accumulated for a predetermined number of cycles N2 of the voltage waveform 120 can be calculated utilizing the following equation:
Q_{Total2}=N2*Qₛ₂=N2*A2*Pₛ₂
Further, the total charge Q_{Total2} is indicative of the temperature of the pyroelectric sensor 34.

The electric circuit 14 generates a signal V_{Diff2} on the node 110 in response to the voltage waveform where 20 corresponding to a difference between the Q_{Total2} electrical charge of the pyroelectric sensor 34 and the Q_{Reference2} charge of the pyroelectric sensor 36. The operational amplifier 100 in conjunction with the capacitor 102 integrates the signal V_{Diff2} over a predetermined time period to generate the signal V_{Int2}, that is indicative of an average temperature of the pyroelectric sensor 34. It should be noted that by integrating the signal V_{Diff2} over time, incoherent noise in the signal V_{Diff2} is canceled out and the signal-to-noise ratio of the signal V_{Int2} is greater than the signal-to-noise ratio of the signal V_{Diff2}. In particular, the signal-to-noise ratio of the signal V_{Int2} is increased by N2^{1/2} for random Gaussian noise, as compared to the signal-to-noise ratio of the voltage signal V_{Diff2}, where N2 represents the number of cycles of the voltage signal 120 applied to the pyroelectric sensor 34.

Further, an active mode effective pyroelectric coefficient P_{eff} for the pyroelectric sensor 34 is defined by the following equation:
P_{eff}=ΔQ2/A2*ΔTₚ₂=N2*ΔPₛ₂/ΔTₚ₂
where:
ΔQ2 is a change in electrical charge of the pyroelectric sensor 34;
A2 is an area of the pyroelectric sensor 34;
ΔTp₂ is a change in a temperature of the pyroelectric sensor 34;
N2 is the number of cycles of the voltage signal 120 applied to the pyroelectric sensor 34; and
ΔPₛ₂ is a change in spontaneous polarization per unit volume due to a temperature change ΔTₚ₂.

Referring to FIG. 1, the image processor 38 receives the voltage signals V_{Int1}, V_{Int2}, from the electrical circuits 12, 14, respectively and generates image data based on the signals.

The system 10 has been described above having electrical circuits 12, 14 for controlling pyroelectric sensors 30, 34, respectively, for purposes of simplicity. It should be noted, however, that a plurality of additional electrical circuits having a substantially similar structure as circuit 12 would be utilized for controlling additional pyroelectric sensors receiving infrared light in the focal plane array 16. Of course, voltage sources for each of the pyroelectric sensors could vary the number of cycles of a voltage waveform applied to the pyroelectric sensors to adjust the corresponding signal-to-noise ratios and sensitivities.

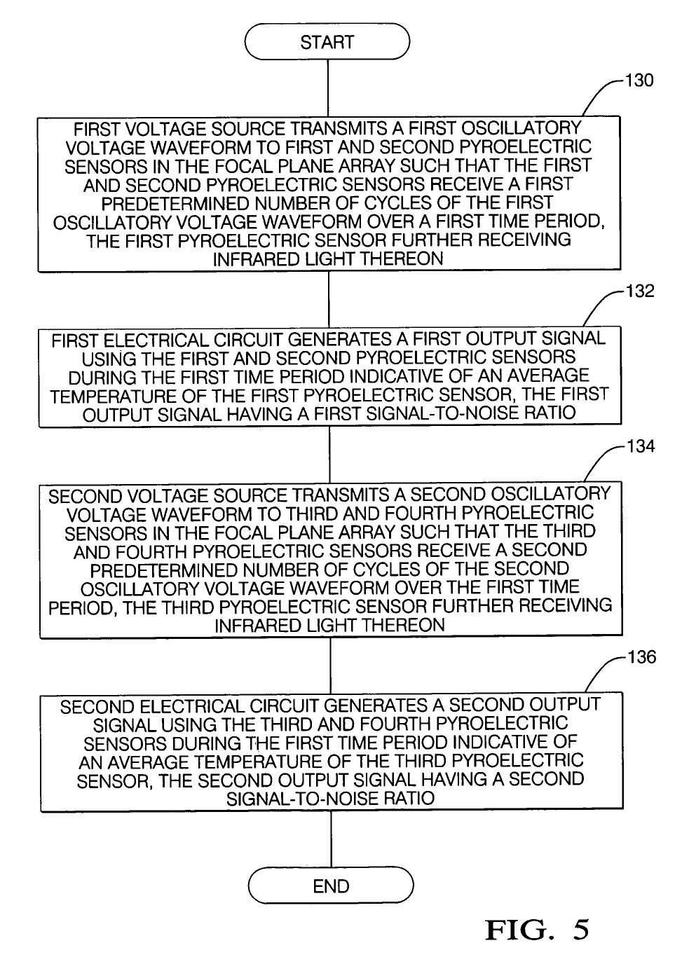

Referring to FIG. 5, a method for controlling the pyroelectric sensors 30, 32, 34, 36 in the focal plane array 16 will now be explained.

At step 130, the voltage source 50 transmits an oscillatory voltage waveform 118 to pyroelectric sensors 30, 32 in the focal plane array 16 such that the pyroelectric sensors 30, 32 receives a first predetermined number of cycles of the oscillatory voltage waveform 118 over a first time period. The pyroelectric sensor 30 further receives infrared light thereon.

At step 132, the electrical circuit 12 generates an output signal V_{Int1} using the pyroelectric sensors 30, 32 during the first time period indicative of an average temperature of the pyroelectric sensor 30. The output signal V_{Int1} has a first signal-to-noise ratio and a first sensitivity level.

At step 134, the voltage source 90 transmits an oscillatory voltage waveform 120 to pyroelectric sensors 34, 36 in the focal plane array 16 such that the pyroelectric sensors 34, 36 receive a second predetermined number of cycles of the oscillatory voltage waveform 120 over the first time period. The pyroelectric sensor 34 receives infrared light thereon.

At step 136, the electrical circuit 14 generates an output signal V_{Int2} using the pyroelectric sensors 34, 36 during the first time period indicative of an average temperature of the pyroelectric sensor 34. The output signal V_{Int2} has a second signal-to-noise ratio and a second sensitivity level. After step 136, the method is exited.

The system and the method for controlling pyroelectric sensors in a focal plane array provide a substantial advantage over other systems and methods. In particular, the system is configured to vary a signal-to-noise ratio and sensitivity of a signal indicative of a temperature of a pyroelectric sensor based on a number of cycles of a voltage waveform applied to the pyroelectric sensor. Thus, a signal-to-noise ratio associated with a first pyroelectric sensor can be adjusted to a first value and a signal-to-noise ratio associated with a second pyroelectric sensor can be adjusted to a second value. Further, a sensitivity of the first pyroelectric sensor can be adjusted to a third value and a sensitivity of the second pyroelectric sensor can be adjusted to a fourth value.

While embodiments of the invention are described with reference to the exemplary embodiments, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited to the embodiment disclosed for carrying out this invention, but that the invention includes all embodiments falling within the scope of the intended claims. Moreover, the use of the term's first, second, etc. does not denote any order of importance, but rather the term's first, second, etc. are used to distinguish one element from another. Furthermore, the use of the terms a, an, etc. do not denote a limitation of quantity, but rather denote the presence of at least one of the referenced items.

What is claimed is:

1. A method for controlling pyroelectric sensors in a focal plane array, comprising:
applying a first oscillatory voltage waveform to first and second pyroelectric sensors in the focal plane array such that the first and second pyroelectric sensors receive a first predetermined number of cycles of the first oscillatory voltage waveform over a first time period, the first pyroelectric sensor receiving infrared radiation thereon;
generating a first output signal using the first and second pyroelectric sensors during the first time period indicative of a temperature of the first pyroelectric sensor;
applying a second oscillatory voltage waveform to third and fourth pyroelectric sensors in the focal plane array such that the third and fourth pyroelectric sensors receive a second predetermined number of cycles of the second oscillatory voltage waveform over the first time period, the third pyroelectric sensor receiving infrared radiation thereon; and
generating a second output signal using the third and fourth pyroelectric sensors during the first time period indicative of a temperature of the third pyroelectric sensor.

2. The method of claim 1, wherein the first predetermined number of cycles of the first oscillatory voltage waveform is greater than the second predetermined number of cycles of the second oscillatory voltage waveform.

3. The method of claim 2, wherein a signal-to-noise ratio of the first output signal is greater than a signal-to-noise ratio of the second output signal.

4. The method of claim 1, wherein the first predetermined number of cycles of the first oscillatory voltage waveform is less than the second predetermined number of cycles of the second oscillatory voltage waveform.

5. The method of claim 4, wherein a signal-to-noise ratio of the second output signal is greater than a signal-to-noise ratio of the first output signal.

6. The method of claim 1, further comprising generating image data based on the first and second output signals utilizing an image processor.

7. A system for controlling pyroelectric sensors in a focal plane array, comprising:
a voltage source configured to apply a first oscillatory voltage waveform to first and second pyroelectric sensors in the focal plane array such that the first and second pyroelectric sensors receive a first predetermined number of cycles of the first oscillatory voltage waveform over a first time period, the first pyroelectric sensor receiving infrared radiation thereon;
a first electrical circuit configured to generate a first output signal using the first and second pyroelectric sensors during the first time period indicative of a temperature of the first pyroelectric sensor;
the voltage source further configured to apply a second oscillatory voltage waveform to third and fourth pyroelectric sensors in the focal plane array such that the third and fourth pyroelectric sensors receive a second predetermined number of cycles of the second oscillatory voltage waveform over the first time period; and
a second electrical circuit configured to generate a second output signal using the third and fourth pyroelectric sensors during the first time period indicative of a temperature of the second pyroelectric sensor.

8. The system of claim 7, wherein the first predetermined number of cycles of the first oscillatory voltage waveform is greater than the second predetermined number of cycles of the second oscillatory voltage waveform.

9. The system of claim 8, wherein a signal-to-noise ratio of the first output signal is greater than a signal-to-noise ratio of the second output signal.

10. The system of claim 7, wherein the first predetermined number of cycles of the first oscillatory voltage waveform is less than the second predetermined number of cycles of the second oscillatory voltage waveform.

11. The system of claim 10, wherein a signal-to-noise ratio of the second output signal is greater than a signal-to-noise ratio of the first output signal.

12. The system of claim 7, further comprising an image processor operably coupled to the first and second electrical circuits configured to generate image data based on the first and second output signals.
